(19) United States
(12) Patent Application Publication
(10) Pub. No.: US 2023/0347597 A1
(43) Pub. Date: Nov. 2, 2023

(54) METHOD FOR MANUFACTURING AN AEROSPACE AND/OR AERONAUTIC TUBULAR COMPOSITE PART AND SUCH A COMPOSITE PART

(71) Applicant: ARIANEGROUP SAS, Les Mureaux (FR)

(72) Inventors: Frederick CAVALIERE, MONTIGNY LE BRETONNEUX (FR); Louis MONROUX, VERSAILLES (FR)

(21) Appl. No.: 18/044,834

(22) PCT Filed: Sep. 10, 2021
(86) PCT No.: PCT/FR2021/051553

§ 371 Date: Mar. 10, 2023

(30) Foreign Application Priority Data
Sep. 11, 2020 (FR) 2009229

(51) Int. Cl. B29C 65/00; B64C 7/02; B29C 65/02; B29C 65/48

(52) U.S. Cl. CPC B29C 66/5344; B64C 7/02; B29C 66/7212; B29C 66/71; B29C 65/02; B29C 65/48

(57) ABSTRACT

A method for manufacturing an aerospace and/or aeronautical composite tubular part, the composite tubular part includes a tubular body and at least one flange. The method includes the following steps: providing at least one composite tubular body portion; forming at least one flange component from a second thermosetting material; a first heat treatment to partially polymerize the flange component or components; assembling the flange component or components on the composite tubular body; a second heat treatment of the composite assembly so as to polymerize both the at least one tubular body portion and the flange component or components. A composite tubular part is also provided.

### CROSS REFERENCE TO RELATED APPLICATIONS

This application is a National Stage of International Application No. PCT/FR2021/051553 having an International Filing Date of 10 Sep. 2021, which designated the United States of America, and which International Application was published under PCT Article 21(2) as WO Publication No. 2022/053768 A1, which claims priority from and the benefit of French Patent Application No. 2009229, filed on 11 Sep. 2020, the disclosures of which are incorporated herein by reference in their entireties.

### BACKGROUND

### Field

The disclosure relates to tubular parts in the aerospace or aeronautical field, such as sleeves.

The disclosure thus more specifically relates to a method for manufacturing a composite tubular part which is aeronautical and/or or aerospace and to such a composite tubular part.

### Brief Description of Related Developments

In the aerospace and aeronautical field it is known, for reducing weight, to use tubular parts comprising a composite body, this being in particular for the space industry in relation to inter-stage skirts and devices for supporting and ejecting satellites known as dispensers, which may be cylindrical structures of constant cross-section or conical structures. It may also be noted that such tubular parts are also used in particular to form casings for divergent nozzles which have a frusto-conical shape or to form air intake structures on turbomachines used in aeronautics.

Such tubular parts generally comprise metal flanges, bonded or bolted to the composite body, to enable their assembly with other parts of the launch vehicle and/or of the aircraft. However, such metal flanges are, given the size of those tubular parts, at the same time costly, have high assembly costs, and are relatively heavy.

By flange is meant, above and in the rest of this document, an assembly member of disk of ring form, more generally being a body of revolution, or even, in some configurations, in the form of portions of a ring or disk. Such a member may or may not have a central opening (that is to say be substantially of annular or disk form), and fit to the section or shape of the structure on which that flange is to be assembled.

For these reasons, it was for a time envisioned to manufacture tubular parts entirely from composites.

Nevertheless, at the current time, none of the manufacturing methods envisioned is satisfactory and makes it possible to envision industrial manufacture of aerospace and/or aeronautical composite tubular parts. Thus, at the present time, such composite tubular parts are not industrially exploited.

### SUMMARY

The disclosure aims to solve the above drawbacks at least partly and is thus directed to providing manufacture of composite tubular parts for aerospace and/or aeronautical application that are easy to industrialize.

To that end, the disclosure relates to a method for manufacturing an aerospace and/or aeronautical composite tubular part, said composite tubular part comprising a tubular body and at least one flange, the method comprising the following steps:
providing at least one composite tubular body portion formed from a first thermosetting material and comprising at least one first wall,
forming at least one flange component formed from at least one second thermosetting material, identical or distinct from the first thermosetting material, said flange component comprising a second wall and at least one flange sector, the second wall having a shape complementary to the first wall and the at least one flange sector extending from said second wall and forming an angle with said second wall,
performing a first heat treatment to partially polymerize the flange component or components,
assembling the flange component or components in contact with the portion or portions of tubular body such that each second wall is in contact with each corresponding first wall, whereby a composite assembly is formed defining the composite tubular body and a composite extension member of the composite tubular part, said composite extension member comprising the flange and having the second wall,
performing a second heat treatment of the composite assembly so as to polymerize both the at least one tubular body portion and the flange component or components, whereby the composite tubular part is obtained with a composite tubular body in the first thermosetting material and a composite extension member in the second thermosetting material assembled to the tubular body by the first and second walls.

The use of partial polymerization of the flange components makes it possible to obtain rigid members at ambient temperature that can thus be stored and manipulated without special conditions.

At the step of forming at least one flange component, several flange components may be formed, each forming a flange annular sector.

In this way, it is possible to form a flange of large size more easily, since it is possible to use flange components of relatively small dimensions relative to that of the flange which will be formed on assembly of those components.

At the second heat treatment, the resin of the partially polymerized flange components will soften, and the viscosity will reduce to return to being practically liquid. This will enable the flange components to fit well to the surface of the composite tubular body and to obtain a good bonding interface once the assembly has fully polymerized.

Such a method thus enables the provision of an entirely composite aerospace or aeronautical tubular part which thus has a reduced mass and cost in relation to the tubular parts of the prior art which have a metal flange.

It will be noted, furthermore, that such a method according to the disclosure is easy to implement, in particular due to the fact that after the first heat treatment, the flange component or components being partially polymerized, the risk of deformation at ambient temperature of the flange component or components is greatly reduced and the flange components can thus easily be moved, stored and repositioned. Similarly, with such a method of formation, it is easy to define the angle between the flange and the second wall and thus of the wall of the composite tubular body. The easy adjustment of the angle that the flange makes with the wall of the tubular body makes it possible to provide facilitated connection of the tubular part with the rest of the launch vehicle or aircraft which it is to equip.

At the second heat treatment, the polymerization of the assembly is complete so as to provide good assembly solidity. In a similar manner, the second heat treatment, like the first heat treatment, is preferably carried out in a single heat cycle.

The disclosure in particular relates to composite tubular parts for a launch vehicle and/or aircraft structure.

At the step of first heat treatment, the first heat treatment may be configured such that the flange component or components have a degree of polymerization, measured by differential scanning calorimetry, comprised between 10 and 75% and preferably comprised between 15 and 40%.

Such a degree of polymerization may be measured in accordance with the standard ISO 11357-1:2016.

The inventors have identified that such a partial polymerization at the same time enables quality storage of the flange components while ensuring good cohesiveness between the flange component or components and the composite tubular body portions or portions after the second heat treatment.

The manufacturing method may further comprise, between the step of performing first heat treatment and the assembling step, the following step:
applying an adhesive film to each first wall and/or second wall at a contact surface between the first wall and the second wall.

Such an adhesive film enables proper assembly between the flange member or members and the composite body portion or portions. Thus, the composite tubular part formed on the basis of such a method has good cohesiveness between the body and the flange carried by the flange member or members.

At least one of the first and of the second thermosetting material is a material comprising a fibrous reinforcement impregnated with a thermosetting resin, the fibrous material preferably being a fabric or a ply the fibers of which are at least one of carbon fibers, glass fibers and poly(p-phenyleneterephthalamide) fibers.

The thermosetting resin preferably being a composition of at least one epoxide resin chosen from bisphenol A diglycidylether resin, diglycidyl para-aminophenol resin and tetraglycidyl methylenedianiline resin, and at least one amine hardener such as a diaminodiphenyl sulfone.

The second thermosetting material may be a material comprising a fibrous reinforcement impregnated with a thermosetting resin, and

the step of forming the at least one flange component comprises the sub-steps of putting into form a fibrous reinforcement, this fibrous reinforcement being either pre-impregnated with a thermosetting resin, or impregnated by a thermosetting resin after it is put into form, the second thermosetting material being said fibrous reinforcement impregnated with said thermosetting resin.

The second thermosetting material may be identical to the first thermosetting material.

In this way, an assembly is obtained between the composite tubular body and the flange member or members.

At the step of forming at least one flange component, several flange components may be formed each forming an annular flange sector, the flange components each comprising a central portion of the flange sector and at least one first circumferential end of the flange sector,

at the step of forming at least one flange component, at least one first flange component having a variable thickness from the central portion towards the first circumferential end.

At the step of forming at least one flange component, at least one second flange component, configured to circumferentially follow the first flange component in succession while overlapping the first circumferential end of the latter at the step of assembling the flange components, has a thickness of the central portion that is variable towards a second circumferential end of the flange sector that is an opposite end to the first circumferential end, in which the variation in thickness of the first and the second flange components are complementary with each other such that on assembly of the flange components the second circumferential end of the second flange component overlaps the first end while together having a substantially constant thickness.

each of the flange components may have a variable thickness from the central portion towards the first circumferential end and from the central portion towards a second circumferential end of the flange sector that is an opposite end to the first circumferential end,

and for a first flange component and a second flange component that are configured to circumferentially follow each other in succession with the second end of the first flange component overlapping the first end of the second flange component at the step of assembling the flange components, the first flange component having a thickness variation from the central portion towards the second end which is complementary with the thickness variation from the central portion towards the first end of the second flange component such that on assembly of the flange components, the second end of the first flange component and the first end of the second flange component together have a substantially constant thickness.

In this way, the assembly between the flange components is provided by overlapping providing good load uptake between the different flange components and thus good solidity of the composite extension member formed when the manufacturing method is implemented.

The composite tubular part may be a sleeve of a launch vehicle, or a satellite dispenser sleeve.

The disclosure concerns an aerospace and/or aeronautical composite tubular part comprising:
a composite tubular body formed from a first thermosetting material, the tubular body comprising at least one first wall,
a composite extension member formed from at least one second thermosetting material, distinct from or identical to the first thermosetting material, said extension member comprising at least one second wall in contact with the correspondent first wall or walls and a flange extending from the second wall or walls and forming an angle with the corresponding second wall or walls, the composite extension member being assembled to the tubular body by the first and second walls.

Since such a composite tubular part may be obtained by means of a method according to the disclosure, it benefits from the advantages linked thereto.

The first and the second thermosetting material may be identical.

In this way an assembly is obtained between the composite tubular body and the composite extension member that is particularly strong.

The composite tubular part may be a sleeve of a launch vehicle, or a satellite dispenser sleeve.

### BRIEF DESCRIPTION OF THE DRAWINGS

The present disclosure will be better understood on reading the description of the example embodiments given purely by way of indication and which is in no way limiting, with reference to the accompanying drawings in which:

FIGS. 1A and 1B respectively illustrate an aerospace and/or aeronautical composite tubular part according to a first embodiment of the disclosure, respectively in a perspective view and a partial radial cross-section view.

FIGS. 2A to 2C illustrate the main steps for manufacturing an aerospace and/or aeronautical composite tubular part according to the first embodiment,

FIGS. 3A to 3E illustrate composite tubular parts, in lateral cross-section view, according to five variants of the first embodiment, FIG. 3A illustrating a possibility for a flange internal to the tubular body of the composite tubular part, FIG. 3B illustrating a frusto-conical tubular part comprising two types of composite extension member disposed at each of the ends of the tubular body of the composite part, the first defining an acute angle with the tubular body, the second defining an obtuse angle, FIG. 3C illustrating a tubular part with a flange disposed at a distance from the openings of the tubular part, FIGS. 3D and 3E each illustrating a tubular part comprising a composite member of thickness greater than that of the tubular body and having a portion extending an end of the tubular body, FIG. 3D illustrating more specifically a composite member having an internal flange and FIG. 3E illustrating more specifically a composite member having an external flange,

FIGS. 4A and 4B respectively illustrate a perspective view of a flange component and a partial view in radial cross-section of a composite tubular part according to a second embodiment of the disclosure in which the flange component, and thus the extension member, have a second wall having no bevel,

FIGS. 5A to 5D respectively illustrate, in radial cross-section view, composite extension members according to a third to a sixth embodiment in which the third and fourth embodiment are variants of the first and second embodiment for which the second wall and a flange portion are connected to each other by a rounded portion, the fifth embodiment being an embodiment in which the flange component further comprises a third wall defining a housing for housing a portion of the tubular body, and the sixth embodiment being a variant of the fifth embodiment in which the flange component defines both an internal flange and an external flange of the composite tubular body.

FIGS. 6A and 6B illustrate in perspective view, for FIG. 6A, a flange component according to a seventh embodiment in which the flange component has a greater thickness over a central portion, the thickness of the flange component reducing towards its ends in a circumferential direction and, for FIG. 6B, a composite tubular part comprising such a flange component,

FIGS. 7A and 7B respectively illustrate, in partial perspective view, a composite tubular part according to an eighth embodiment in which the flange component also has a reduction in the thickness of the component towards its ends, and a ninth embodiment of the disclosure in which the flange is formed by superposition of two types of flange components in a staggered configuration.

FIG. 8 illustrates a perspective view of a composite tubular part according to a tenth embodiment of the disclosure.

Parts that are identical, similar or equivalent in the various figures bear the same numerical references so as to facilitate the passage from one figure to the other.

The various parts shown in the figures are not necessarily at a uniform scale, so as to render the drawings easier to read.

The various possibilities (variants and embodiments) must be understood as not being exclusive of each other and may be combined between each other.

### DETAILED DESCRIPTION

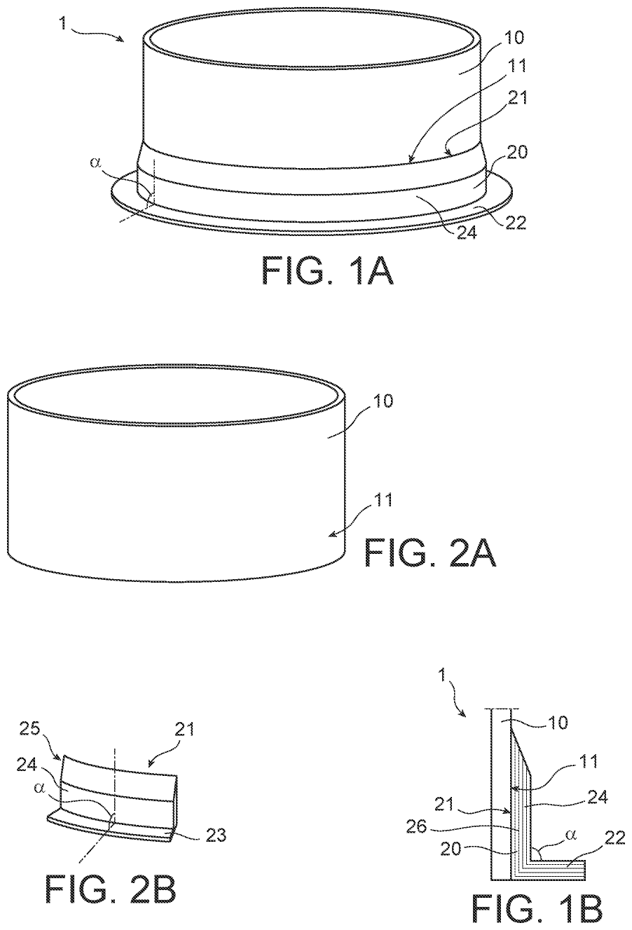

FIGS. 1A and 1B illustrate a composite tubular part 1 for aerospace or aeronautical application according to a first embodiment, the tubular part comprising a composite tubular body 10 and a composite extension member 20 of the composite tubular part 1 comprising a flange 22.

Such a composite tubular part 1 may be a sleeve of a launch vehicle or of an aircraft forming, for example, an inter-stage skirt or for example a dispenser for satellite support and ejection.

In such a composite tubular part 1, the composite tubular body 10 takes the form of a cylindrical envelope that is a solid of revolution, with open bases. In this first embodiment a tubular body 10 forms at least one first wall 11. The tubular body 10 is formed from a first thermosetting material.

According to a preferred possibility for the disclosure, the first thermosetting material may be a material obtained by polymerization of a thermosetting material comprising a fibrous reinforcement impregnated by a thermosetting resin.

The fibrous reinforcement may be a fabric or a ply of which the fibers are at least one of carbon fibers, glass fibers and fibers of poly(p-phenyleneterephthalamide) (denoted PPD-T and known by its trade name Kevlar™).

The thermosetting resin may comprise a composition of monomer and/of pre-polymer, such as an epoxide resin, and a hardener. The epoxide resin may be chosen from bisphenol A diglycidylether resin (denoted DGEBA and known as diglycidyl ether of Bisphenol A), diglycidyl para-aminophenol resin (denoted TGPAP and known as tetraglycidyl methylenedianiline) and tetraglycidyl methylenedianiline resin (denoted TGMDA and known as diaminodiphenyl sulfone) and mixtures thereof. The hardener may be an amine type hardener such as diaminodiphenyl sulfone (denoted DDS).

As is specified below in the context of the description of a method for manufacturing a tubular part 1 according to the first embodiment, the tubular body 10 may be formed:
from a single part obtained by putting the first thermosetting material into form, such as by laying-up a fabric, or a ply, that is pre-impregnated, or
according to a possibility not illustrated, by an assembly of tubular body portions, each of said portions being obtained by putting into form the first thermosetting material, such as by laying-up a fabric, or a ply, that is pre-impregnated.

The extension member 20 has an annular shape with a tubular portion 24, having at least one second wall 21 that is complementary to the first wall 11 and a flange 22 extending from the tubular portion 24, and thus from the second wall or walls 21, forming an angle α. More specifically, in this first embodiment, the flange 22 extends outwardly of the composite tubular part 1, that is to say that it extends radially form the extension member 20 in the opposite direction to an axis of revolution of the composite tubular body 10.

In the present embodiment, as illustrated in FIG. 1B, the angle α formed between the tubular portion 24 and the flange is substantially equal to 90°. Of course, such a value is given by way of example, the angle formed between the flange 22 and the second wall or walls 21 may be different without departing from the scope of the disclosure.

By “the flange 22 forms an angle with the second wall or walls” is meant, above and in the rest of this document, that the flange does not extend in line with the second wall or walls 21 and thus that the angle α formed between the flange 22 and the second wall or walls 21 is different from 180°, since there would thus be no angle as such. Thus, in a standard configuration of the disclosure, the angle α formed between the tubular portion 24 and the flange may be comprised between 170° and 10°, preferably between 150° and 30°, and particularly advantageously between 110° and 70°.

The tubular portion 24 is complementary to the composite tubular body 10 and is assembled to the latter while presenting the second wall or walls 21 in contact with the corresponding first wall 11. Thus, in the present configuration, the surface of the tubular portion 24 facing opposite the first wall 11, that is to say the inside surface of the tubular portion 24, forms the second wall or walls 21.

The tubular portion 24 has, on an opposite end to the flange, a variable thickness so as to form a bevel. In this way, the assembly between the composite tubular body 10 and the tubular portion 24 does not have any abrupt edge.

It is to be noted that such a bevel may be obtained by successive yielding of pre-impregnated plies or layers when laying-up the flanges, leading to this reduction in thickness at the flange ending.

As illustrated in FIG. 1A, in the present embodiment, the flange 22 takes a form of a planar corona extending from the tubular portion 24 to form the angle α. On account of its fastening functions that it provides to the composite tubular part 1 which it equips, the flange 22 is able to integrate metal inserts, not illustrated, having openings that may or may not be through openings, with or without tapping, for example such as rings, spacers or tapped nuts, for installation of fastenings.

The extension member 20 is formed from a second thermosetting material, identical to or distinct from the first thermosetting material.

According to a preferred possibility for the disclosure, the second thermosetting material may be a material obtained by polymerization of a thermosetting material comprising a fibrous reinforcement impregnated by a thermosetting resin.

The fibrous reinforcement of such a second thermosetting material is a fabric or a ply of which the fibers are at least one of carbon fibers, glass fibers and fibers of poly(p-phenyleneterephthalamide) (denoted PPD-T and known by its trade name Kevlar™).

The thermosetting resin of such a second thermosetting material comprises a composition of monomer and/of pre-polymer, such as an epoxide resin, and a hardener. The epoxide resin may be chosen from bisphenol A diglycidylether resin (denoted DGEBA and known as diglycidyl ether of Bisphenol A), diglycidyl para-aminophenol resin (denoted TGPAP and known as tetraglycidyl methylenedianiline) and tetraglycidyl methylenedianiline resin (denoted TGMDA and known as diaminodiphenyl sulfone) and mixtures thereof. The hardener may be an amine type hardener such as diaminodiphenyl sulfone (denoted DDS).

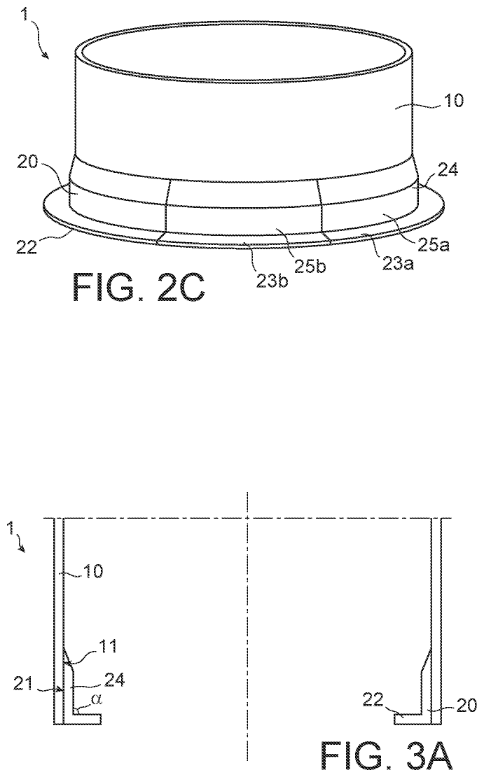

As will be specified below in the description of the method for manufacturing the composite tubular part 1 according to the first embodiment, the extension member 20 may be formed:
as a single part, the extension member 20 then forming a flange component as such, obtained by putting into form the second thermosetting material, such as by laying-up a pre-impregnated fabric, or
according to a preferred possibility which is described below in connection with FIGS. 2A to 2C, by an assembly of a plurality of flange components 25, each of said flange components 25 being obtained by putting into form the second thermosetting material, such as by laying-up a pre-impregnated fabric or laying-up a fabric s impregnated with a thermosetting resin after it is put into form, the second thermosetting material being said fibrous reinforcement impregnated with said thermosetting resin.

More generally, and whatever the configuration chosen, as illustrated in FIG. 1B and particularly advantageously, the flange component or components 25 may be manufactured from a fabric or ply multilayer member 26 that is pre-impregnated, or impregnated, with a thermosetting resin. Each of the layers of the multilayer member extends over the whole height of the tubular portion 24 and over the whole length of the flange 22 such that the multilayer member is continuous over the entirety of the flange component. In this way, continuity of the fibers of the second material is ensured and thus a good load-bearing capacity of the flange component or components 25.

Thus, according to this second possibility, the extension member 20 may be produced by an assembly of several flange components 25, such as that illustrated in FIG. 2B. In this first embodiment, such a flange component 25 takes the form of a sector portion of the extension member 20. The flange component 25 thus comprises a sector of the tubular portion 24 delimiting the second wall of said flange component 25, and a flange sector 23.

As illustrated in FIGS. 2A to 2C and FIG. 1A, a composite tubular part 1 according to this first embodiment may be manufactured with a manufacturing method comprising the following steps:
providing the composite tubular body 10 formed from the first thermosetting material and comprising the first wall 11, as illustrated in FIG. 2A,
forming a plurality of flange components 25, each flange component 25 being formed from the second thermosetting material and comprising a second wall 21 and at least one flange sector 23, the second wall 21 having a form complementary to the first corresponding wall 11 and the at least one flange sector extending from said second wall 21 while forming the angle α with said second wall, such a flange component being shown in FIG. 2B,
performing a first heat treatment to partially polymerize the flange component or components 25,
assembling the flange components 25 in contact with the tubular body 10 such that each second wall 21 is in contact with each corresponding first wall 11, whereby a composite assembly is formed defining the composite tubular body 10 and a composite extension member 20 of the composite tubular part 1 comprising the flange 22, as illustrated in FIG. 2C,
performing second heat treatment of the composite assembly so as to fully polymerize both the tubular body 10 and the flange components 25, whereby the composite tubular part 1 is obtained with a composite tubular body 10 of the first thermosetting material and a composite extension member 20 in the second thermosetting material assembled to the tubular body by the first and second walls 11, 21, as illustrated in FIG. 1.

The second heat treatment of the assembly is preferably produced in the form of a single heat cycle, so as to provide good quality polymerization.

The thermosetting resins used and described in this document fully polymerize at a temperature generally comprised between 120° C. and 220° C. over a time of two hours at polymerization temperature. More specifically, the resins most used in the space and aeronautical field are what is referred to as resins of 180° C. class, for which full polymerization is attained after 2 h at 180° C.

It will furthermore be noted that the first heat treatment may be carried out by subjecting the flange components 2 to a temperature less than the polymerization temperature of the second thermosetting material, this being to give partial polymerization.

It will be noted that, due to the size of the composite tubular body 10 and as a variant, at the step of providing the composite tubular body 10, this may be provided in the form of several composite tubular body portions which are then assembled to form the composite tubular body 10. According to this possibility, not illustrated, the assembly of the tubular body portions may be carried out in the context of the step of providing the composite tubular body 10, at the step of assembling the flange components 25 or at a step that is intermediate in relation to these two steps.

Similarly and preferably, at the step of first heat treatment, the first heat treatment is configured such that the flange component or components 25 have a degree of polymerization, measured by differential scanning calorimetry (DSC), comprised between 10 and 75% and preferably comprised between 15 and 40%.

According to a possibility of the disclosure, the manufacturing method may further comprise, between the first heat treatment and the assembly step, the following step:
applying an adhesive film on the or each first wall 11 and/or the or each second wall 21, and at the location of a contact surface between said first walls and second walls.

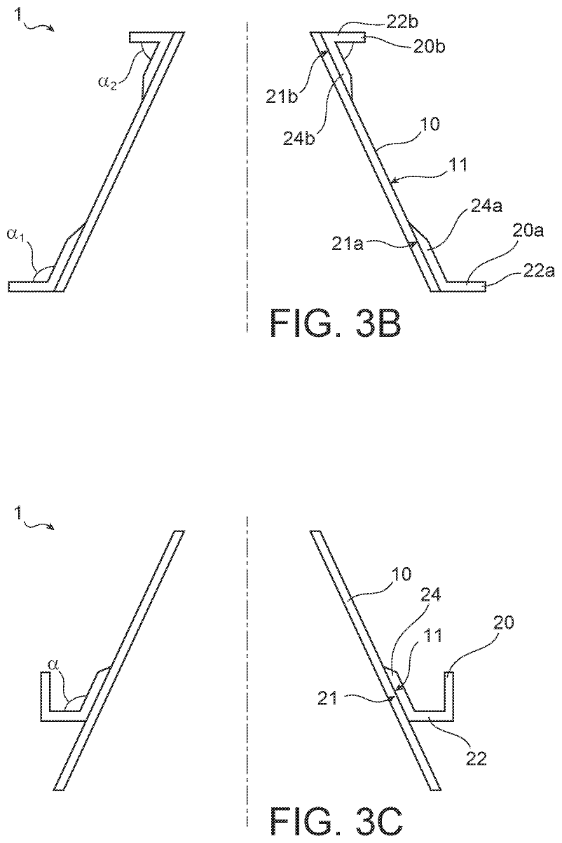

FIG. 3A illustrates a partial view in axial cross-section of a composite tubular part according to a first variant of a tubular part according to the first embodiment in which the flange 22 extends in a first inward direction of the composite tubular part 1, that is to say that it extends radially from the composite extension member 20 in the direction of an axis of revolution of the composite tubular body 10. In other words, in this variant, the flange 22 is oriented inwardly of the tubular body 10.

Thus a composite tubular part 1 according to this variant of the first embodiment is differentiated from a tubular part according to the first embodiment only in that:
an inside surface of the composite tubular body 10 forms the at least one first wall 11, an outside surface of the composite extension member 20 forming the second wall or walls 21.
the flange 22 extends in an inward direction of the composite tubular part 1, that is to say that it extends radially from the composite extension member 20 towards the axis of revolution of the composite tubular body 10.

A composite tubular part 1 according to this variant of the first embodiment may be manufactured, except for the shapes of the composite tubular part 10 and the composite extension member 20, by a manufacturing method according to the embodiment.

FIG. 3B illustrates an axial cross-section view of a composite tubular part according to a second variant of a composite tubular part 10 according to the first embodiment, in which the composite tubular body 10 has a substantially frusto-conical shape with open bases and in which the tubular part comprises a first and a second composite extension member 20a, 20b respectively at the location of the first and the second open base of the composite tubular part 10.

Thus a composite tubular part 1 according to this variant of the embodiment is differentiated from a tubular part according to the first embodiment only in that:
the composite tubular body 10 has a frusto-conical shape,
the composite tubular part 10 comprises the first and the second composite extension member 20a, 20b,
the flange 22a of the first composite extension member 20a presents, with the second wall, an angle α₁ which is equal to a right angle added to the cone angle of the composite frusto-conical body 10,
the flange 22b of the second composite extension member 20b presents, with the second wall, an angle α2 which is equal to a right angle from which is subtracted the cone angle of the composite frusto-conical body 10, this being such that the flanges of the first and the second composite extension member are parallel to each other.

Of course, this is a simple example embodiment and it is possible to provide a composite tubular part having two flanges with any angles α₁ and α₂ and without the flanges of the first and of the second composite extension member necessarily being parallel to each other.

A composite tubular part 1 according to this variant of the first embodiment may be manufactured using a manufacturing method that is differentiated from the manufacturing method according to the first embodiment in that:
at the step of forming at least one flange component produced from at least one second thermosetting material, there are produced both the flange component or components for forming the first composite extension member 20a and the flange component or components for forming the second composite extension member 20b, and
at the step of assembling the flange component or components, the flange component or components corresponding to the first extension member are assembled to form the first composite extension member 20a and the flange component or components corresponding to the second extension member are assembled to form the second composite extension member 20b.

It will be noted that such a frusto-conical form of the composite tubular body 10 is particularly advantageous if the extension member is produced in the form of a single flange component, since the assembly may be made simply by putting in place of the member by passing it via the base of the composite tubular body 10 of small diameter. As a matter of fact, the frusto-conical shape makes it possible to provide proper positioning of the member on the composite tubular body, this naturally finding its place by shape complementarity.

Naturally, in the context of such a manufacturing method, the step of forming at least one flange component may comprise two distinct sub-steps for respectively forming the first composite extension member 20a and the second composite extension member 20b. Thus, the first and the second composite extension member 20a, 20b may perfectly well be manufactured at different times and at different places.

FIG. 3C illustrates an axial cross-section view of a composite tubular part according to a third variant of a composite tubular part 10 according to the first embodiment in which the extension member 20 is disposed on an intermediate portion of the composite tubular body 10 and in which the extension member 20 has a U-shaped radial cross-section. With such a U shape, a first arm of the U corresponding to the second wall 21, the base of the U corresponds to the flange 22, and a second arm of the U corresponds to a wall said to be vertical.

Thus, in such a variant, the flange is arranged on an intermediate portion of the composite tubular body 20 at a distance from the axial ends of that same composite tubular body 20.

FIG. 3D illustrates, with an axial cross-section view, a composite tubular part according to a fourth variant of a composite tubular part 10 according to the first embodiment in which the tubular portion 24 of the extension member 20 has the second wall 21 only over part of its height.

Thus, according to this variant, the tubular portion 24 has the second wall 21 at the location of a first end of the aforementioned which is an opposite end to the flange 20 and which has a smaller thickness relative to the rest of the tubular portion 24. The tubular portion 24 furthermore has an intermediate portion between the first end and a second end from which extends the flange 20 and which has a greater thickness to that of the composite tubular body 10. The intermediate portion has a variable thickness between the thickness of the first end and a thickness of the second end this being so as to coincide with a beveled end of the composite tubular body 10 with which the intermediate portion is in contact. Thus, the tubular portion 24 is assembled to the composite tubular body 10 by the first end, having the second wall 21, and by the intermediate portion, ensuring good cohesiveness between them.

Of course, if according to this fourth variant, the tubular portion 24 of the extension member 20 has a greater thickness than that of the composite tubular body 10, it may perfectly well be envisioned for the tubular portion 24 of the extension member 20 to have a thickness equal to, or less than, that of the composite tubular body 10, without departing from the scope of the disclosure.

According to this fourth variant, the flange extends radially inwardly of the composite tubular part 10.

FIG. 3E illustrates, in an axial cross-section view, a composite tubular part according to a fifth variant of a composite tubular part 10 according to the first embodiment in which the extension member 20 in which the composite tubular part is different from the composite tubular part according to the fourth variant in that the flange 20 extends radially outwardly of the composite tubular part 10.

In the same way as for the fourth variant, the tubular portion 24 of the extension member 20 according to this fifth variant has a greater thickness than that of the composite tubular body 10, it may nevertheless be perfectly well envisioned for the tubular portion 24 of the extension member 20 to have a thickness equal to, or less than, that of the composite tubular body 10, without departing from the scope of the disclosure.

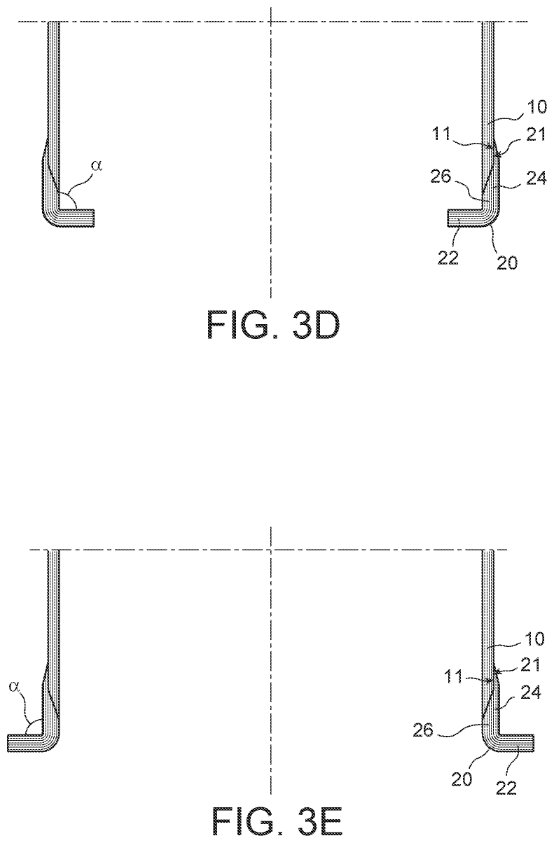

FIGS. 4A and 4B respectively illustrate a flange component 25 and a partial view of a composite tubular part 1 according to a second embodiment in which the tubular portion 24 of the extension member 20 does not have a bevel on the opposite end to the flange 20.

Thus, a composite tubular part 1 according to this second embodiment is different from a composite tubular part 1 according to the first embodiment in that the tubular portion 24 of the composite extension member 20 does not have a bevel on the opposite end to the flange 20. In other words, the composite extension member 20 has uniform thickness in an axial direction.

In addition to the shape of the flange component or components 25, which does or does not have a bevel, the method for manufacturing a composite tubular part 1 according to this second embodiment is similar to that of a composite tubular part 1 according to the first embodiment.

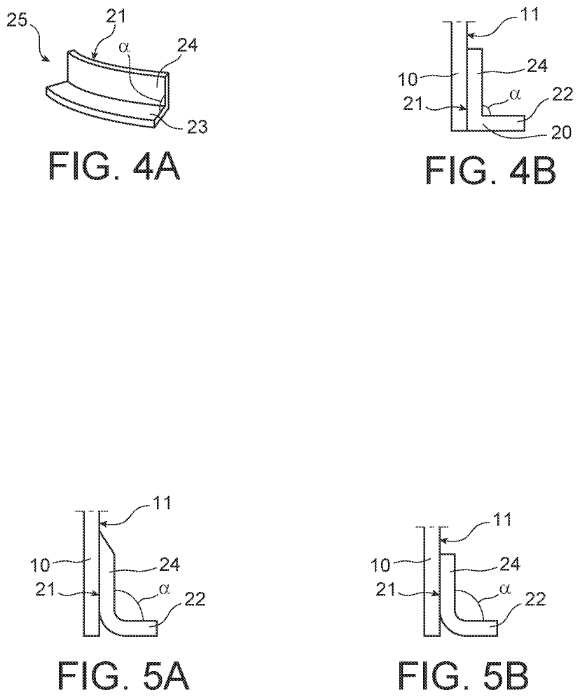

FIGS. 5A to 5D illustrate flange components 25 of a composite tubular part 1 respectively according to a third, a fourth, a fifth and a sixth embodiment of the disclosure.

In the third embodiment, the flange component 25 is different from a tubular flange component 25 according to the first embodiment in that the flange sector 23 and the sector of tubular portion 24 are connected to each other by a curved portion instead of a join at an abrupt angle (or edge).

In the fourth embodiment, the flange component 25 is different from a tubular flange component 25 according to the second embodiment in that the flange sector 23 and the sector of tubular portion 24 are connected to each other by a curved portion instead of a join at an abrupt angle (or edge).

Thus, the method for manufacturing a composite tubular part 1 according to the third and the fourth embodiment is different from a method for manufacturing a composite tubular part 1 respectively according to the first and the second embodiment in that at the step of forming the flange component or components 25, the flange component or components 25 formed each have the flange sector 23 and the sector of tubular portion 24 connected to each other by a curved portion instead of a join at an abrupt angle (or edge).

As illustrated in FIG. 5C, a composite tubular part 1 according to the fifth embodiment is different from a composite tubular part 1 according to the first embodiment in that the sector of tubular portion comprises a first and second second wall 21, 21′ defining a housing for housing an end of the composite tubular body 10.

Thus, according to this fifth embodiment, the tubular portion 24 has a U-shaped radial section, each of the inside surfaces of the U defining one of the first and the second walls 21, 21′ and the flange 22 extending from the base of the U. The tubular portion 24 is dimensioned to house one end of the composite tubular body 10 with the first second wall 21 in contact with a first first wall of the tubular body 10, not illustrated, and the second second wall 21 in contact with a second first wall of the tubular body 10, not illustrated. In this way, in this fifth embodiment, the tubular portion 24 has inside walls of its U-section, that is to say the first and second second walls 21, 21′, in contact with the walls of the composite body 10 forming a first and a second first wall.

In this same fifth embodiment, the inside surface of the tubular body defines the first first wall and the outside surface of the composite tubular body 10 defines the second first wall of the composite tubular body 10.

A composite tubular part 1 according to this fifth embodiment is different from the method for manufacturing a composite tubular part according to the first embodiment in that:
at the step of forming the flange component or components 25, the or each component has a U-shaped sector portion of the tubular portion 24 with a first and a second second wall from which extends the corresponding flange or the flange sector,
at the step of assembling the flange component or components, the assembly is carried out in such a way that one end of the composite tubular body becomes housed in the housing defined by the tubular portion 24.

As illustrated in FIG. 5D, the composite tubular part 1 according to the sixth embodiment is different from a composite tubular part 1 according to the fifth embodiment in that the flange 20 extends on opposite sides of the tubular portion 124.

Thus, according to this sixth embodiment the flange 22 extends, as regards a first portion, radially towards the axis of revolution of the composite tubular body 10, and, for a second portion, radially in an opposite direction to the axis of revolution of the composite tubular body 10.

A method for manufacturing a composite tubular part 1 according to this sixth embodiment differs from a method for manufacturing a composite tubular part 1 according to the fifth embodiment in that at the step of forming the flange component or components 25, the flange or flange sector of the flange component or components 25 extends at the same time radially towards the axis of revolution and in the opposite direction to that same axis.

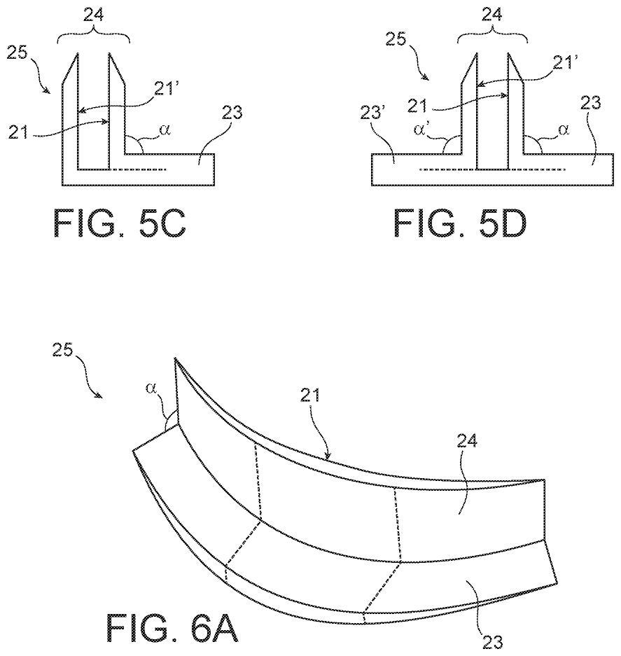

FIGS. 6A and 6B respectively illustrate a flange component 25 and a composite tubular part 1 according to a seventh embodiment in which each flange component 25a, 25b has a circumferentially variable thickness of the flange sector 23 and of the sector of tubular portion 24. Thus, a composite tubular part 1 according to this seventh embodiment differs from a composite tubular part according to the second embodiment in that the flange components 25a, 25b have a circumferentially variable thickness.

Thus, as shown in FIG. 6A, the flange component 25a illustrated therein has, going in a circumferential direction, a first end, a central portion, and a second end succeeding each other circumferentially. The flange component 25a has a central portion of thickness equal to the thickness of the flange 22, while the thickness of the first end and of the second end each have a thickness that reduces from the central portion towards said end.

Such a flange component 25a, as shown by FIG. 6B, is, at the step of assembling the flange components 25a, 25b, assembled to a second flange component which succeeds it circumferentially and which also comprises a first end, a central portion and a second end which succeed each other circumferentially. In the same way as the first flange component 25a, the second flange component 25b has a central portion of thickness equal to the thickness of the flange 22, and a second end of variable thickness that is complementary to the variable thickness of the first end of the first flange component 25a.

Thus, at the step of assembling the flange components 25a, 25b, the first and the second flange components 25a, 25b are assembled to each other with the second end of the second flange component 25b overlapping the first end of the first flange component 25a in such a way that the flange 22 has a constant thickness.

A method for manufacturing a composite part 1 according to this seventh embodiment differs from a method for manufacturing a composite part 1 according to the second embodiment in that:
at the step of forming the flange components 25a 25b, the flange components 25a, 25b are formed with a variable thickness,
at the step of assembling the flange components 25a, 25b, the flange components 25a, 25b partly overlap.

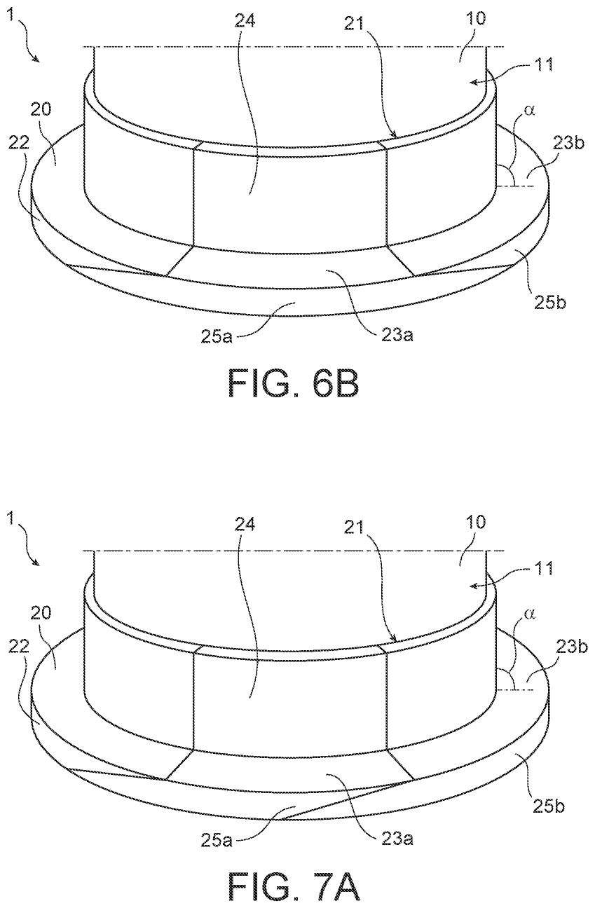

FIGS. 7A and 7B illustrate an eighth and a ninth embodiment in which, according to a similar principle to the seventh embodiment, upon assembly of the flange components, these overlap each other at least partly.

Thus, as shows FIG. 7A, in the eighth embodiment, the composite tubular part 1 differs from a composite tubular part 1 according to the seventh embodiment in that all the flange components 25a, 25b are identical and in that the first and second end of each component have a variable thicknesses that are complementary to each other. In this way, upon assembly of the flange components 25a, 25b and with such complementarity of thickness variability, the second end of the first flange component and the first end of the second flange component together have a substantially constant thickness.

In this way, the method for manufacturing a composite tubular part 1 according to this eighth embodiment differs from a manufacturing method according to the second embodiment in that:
at the step of forming the flange components 25a 25b, the flange components 25a, 25b are formed with a complementary variable thickness,
at the step of assembling the flange components 25a, 25b, the flange components 25a, 25b overlap partly with, for two flange components that succeed each other circumferentially, the second end of one overlapping with the first end of the other to form the flange 20, in a roof-tiling configuration of the flange components.

In the ninth embodiment, as FIG. 7B shows, each flange component 5a, 25b, 25c, 25d has a thickness which is half that of the flange 22 and said flange components 25a, 25b, 25c, 25d take the form of two types of flange component, the upper flange components 25a, 25c and the lower flange components 25b, 25d.

Thus, a composite tubular part 1 according to this ninth embodiment differs from a composite tubular part 1 according to the second embodiment in that the composite extension member 20 is formed by an assembly of flange components 25a, 25b, 25c, 25d of two types.

More specifically, in this ninth embodiment, the flange components 25a, 25c which are referred to as being upper, comprise a section of flange 23a, 23b of a thickness equal to half the thickness of the flange 22 and a sector of tubular portion of thickness equal to half the thickness of the tubular portion 24 of the composite extension member. The flange components 25a, 25c are shaped to be arranged contact with the flange components 25b, 25d referred to as being lower.

The lower flange components 25b, 25d also comprise a section of flange 23b, 23d of a thickness equal to half the thickness of the flange 20 and a sector of tubular portion of a thickness equal to half the thickness of the tubular portion 24 of the composite extension member 20, the sectors of tubular portion each defining part of the second wall 21.

Thus, the composite tubular part according to this ninth embodiment, as shown in FIG. 7B, has the lower flange components 25b, 25d assembled to the tubular body with the second wall 21 in contact with the first wall 11, and the upper flange components 25a, 25c assembled to the lower flange components 25b, 25 in staggered arrangement. In this way, an upper flange component 25a, 25c overlaps the contact zone between two lower flange components 25b, 25d.

It will be noted that although in the present embodiment, the upper flange components 25a, 25c and the lower flange components 25b, 25c may have identical thicknesses, it may also be envisioned for them to have thicknesses different from each other, without departing from the scope of the disclosure. In the same way, the flange components may have bevels at the ends of the flange section and/or of the tubular portion to be assembled together with overlapping. As a variant, these same flange components may have a curved zone which may be, for example, of the same type as that described in connection with FIGS. 5A and 5B.

The method for manufacturing a composite tubular part 1 according to this ninth embodiment differs from a manufacturing method according to the second embodiment in that:
at the step of forming the flange components 25a 25b, flange components 25a, 25b, 25c, 25d of two types are formed, lower flange components 25a, 25c and upper flange components 25b, 25d,
at the step of assembling the flange components 25a, 25b, 25c, 25d, the lower flange components 25b, 25d are arranged directly in contact with the composite tubular body 10 and the upper flange components 25a, 25c are arranged in contact with the lower flange components 25b, 25d.

It will be noted that that in the context of this manufacturing method, an adhesive film may be positioned just as well between the lower flange components 25a, 25c and the composite tubular body, as between the lower flange components 25a, 25c and the upper flange components 25b, 25d.

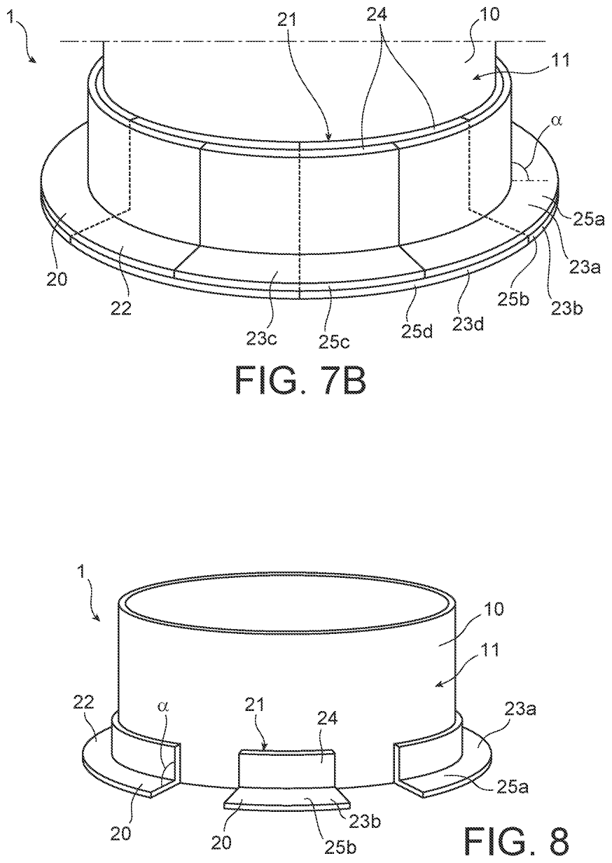

FIG. 8 illustrates a composite tubular part 1 according to a tenth embodiment in which the flange 22 is a discontinuous flange. A composite tubular part 1 according to this tenth embodiment differs from a tubular part 1 according to the second embodiment in that the flange 22 is a discontinuous flange.

In this tenth embodiment, the discontinuity of the flange 22 is obtained by an assembly of the flange components 25a, 25b on the composite tubular body 10 at a distance from each other circumferentially.

Thus, the method for manufacturing a composite tubular part 1 according to this tenth embodiment differs from a composite tubular part 1 according to the second embodiment in that:
at the step of forming flange components 25a, 25b, the flange components 25a, 25b are dimensioned so as to only cover part of the circumference of the composite tubular body 1,
at the step of assembling flange components 25a, 25b, the flange components are assembled to the composite tubular body 10 at a distance from each other circumferentially.

Naturally, the shapes of the tubular parts, flange, tubular body portion and flange components described in the present embodiments are given only by way of example of embodiments of the disclosure and are in no way limiting, it being possible to envision other shapes, curves or cross sections without departing from the scope of the disclosure.

What is claimed is:

1. A method for manufacturing an aerospace and/or aeronautical composite tubular part, the composite tubular part comprising a tubular body and at least one flange, the method comprising the following steps:
providing at least one composite tubular body portion formed from a first thermosetting material and comprising at least one first wall,
forming at least one flange component formed from at least one second thermosetting material, identical or distinct from the first thermosetting material, the flange component comprising a second wall and at least one flange sector, the second wall having a shape complementary to the first wall and the at least one flange sector extending from the second wall and forming an angle (α, α′) with the second wall,
performing a first heat treatment to partially polymerize the flange component or components,
assembling the flange component or components in contact with the portion or portions of tubular body such that each second wall is in contact with each corresponding first wall, whereby a composite assembly is formed defining the composite tubular body and a composite extension member of the composite tubular part, the composite extension member comprising the flange and having the second wall,
performing a second heat treatment of the composite assembly so as to polymerize both the at least one tubular body portion and the flange component or components, whereby the composite tubular part is obtained with a composite tubular body in the first thermosetting material and a composite extension member in the second thermosetting material assembled to the tubular body by the first and second walls.

2. The method for manufacturing the aerospace and/or aeronautical composite tubular part according to claim 1, wherein at the step of first heat treatment, the first heat treatment is configured such that the flange component or components have a degree of polymerization, measured by differential scanning calorimetry, comprised between 10 and 75% and preferably comprised between 15 and 40%.

3. The method for manufacturing the aerospace and/or aeronautical composite tubular part according to claim 1 further comprising, between the step of performing first heat treatment and the assembling step, the following step:
applying an adhesive film to each first wall and/or second wall at a contact surface between the first wall and the second wall.

4. The method for manufacturing the aerospace and/or aeronautical composite tubular part according to claim 1, wherein at least one of the first and of the second thermosetting material is a material comprising a fibrous reinforcement impregnated with a thermosetting resin, the fibrous material preferably being a fabric or a ply the fibers of which are at least one of carbon fibers, glass fibers and poly(p-phenyleneterephthalamide) fibers, the thermosetting resin preferably being a composition of at least one epoxide resin chosen from bisphenol A diglycidylether resin, diglycidyl para-aminophenol resin and tetraglycidyl methylenedianiline resin, and at least one amine hardener such as a diaminodiphenyl sulfone.

5. The method for manufacturing the aerospace and/or aeronautical composite tubular part according to claim 4, wherein the second thermosetting material is a material comprising a fibrous reinforcement impregnated with a thermosetting resin, and
wherein the step of forming the at least one flange component comprises the sub-steps of putting into form a fibrous reinforcement, this fibrous reinforcement being either pre-impregnated with a thermosetting resin, or impregnated by a thermosetting resin after it is put into form, the second thermosetting material being the fibrous reinforcement impregnated with the thermosetting resin.

6. The method for manufacturing the aerospace and/or aeronautical composite tubular part according to claim 1, wherein the second thermosetting material is identical to the first thermosetting material.

7. The method for manufacturing the aerospace and/or aeronautical composite tubular part according to claim 1, wherein at the step of forming at least one flange component, several flange components are formed each forming an annular flange sector, the flange components each comprising a central portion of the flange sector and at least one first circumferential end of the flange sector,
wherein at the step of forming at least one flange component, at least one first flange component has a variable thickness from the central portion towards the first circumferential end.

8. The method for manufacturing the aerospace and/or aeronautical composite tubular part according to claim 7, wherein at the step of forming at least one flange component, at least one second flange component, configured to circumferentially follow the first flange component in succession while overlapping the first circumferential end of the latter at the step of assembling the flange components, has a thickness of the central portion that is variable towards a second circumferential end of the flange sector that is an opposite end to the first circumferential end, in which the variation in thickness of the first and the second flange components are complementary with each other such that on assembly of the flange components the second circumferential end of the second flange component overlaps the first end while together having a substantially constant thickness.

9. The method for manufacturing the aerospace and/or aeronautical composite tubular part according to claim 7, wherein each of the flange components has a variable thickness from the central portion towards the first circumferential end and from the central portion towards a second circumferential end of the flange sector that is an opposite end to the first circumferential end,
and wherein for a first flange component and a second flange component that are configured to circumferentially follow each other in succession with the second end of the first flange component overlapping the first end of the second flange component at the step of assembling the flange components, the first flange component having a thickness variation from the central portion towards the second end which is complementary with the thickness variation from the central portion towards the first end of the second flange component such that on assembly of the flange components, the second end of the first flange component and the first end of the second flange component together have a substantially constant thickness.

10. The method for manufacturing the aerospace and/or aeronautical composite tubular part according to claim 1, wherein at the step of assembling the flange component or components in contact with the portion or portions of tubular body is carried out in such a way that each second wall is in contact with each first corresponding wall at the location of a portion of the tubular body.

11. The method for manufacturing the aerospace and/or aeronautical composite tubular part according to claim 1, wherein the composite tubular part is a sleeve of a launch vehicle, or a satellite dispenser sleeve.

12. An aerospace and/or aeronautical composite tubular part comprising:
a composite tubular body formed from a first thermosetting material, the tubular body comprising at least one first wall,
a composite extension member formed from at least one second thermosetting material, distinct from or identical to the first thermosetting material, the extension member comprising at least one second wall in contact with the correspondent first wall or walls and a flange extending from the second wall or walls and forming an angle (α,α′) with the corresponding second wall or walls, the composite extension member being assembled to the tubular body by the first and second walls.

13. The aerospace and/or aeronautical composite tubular part according to claim 12, wherein the first and the second thermosetting material are identical.

14. The aerospace and/or aeronautical composite tubular part according to claim 13, which is a sleeve of a launch vehicle, or a satellite dispenser sleeve.
